(19) United States
(12) Patent Application Publication
(10) Pub. No.: US 2006/0196114 A1
(43) Pub. Date: Sep. 7, 2006

(54) Combination watering and aerating unit

(76) Inventor: David M. Allen, Howell, MI (US)

Correspondence Address: HARNESS, DICKEY & PIERCE, P.L.C., P.O. BOX 828, BLOOMFIELD HILLS, MI, 48303, US

(21) Appl. No.: 11/073,491

(22) Filed: Mar. 4, 2005

(51) Int. Cl. A01G 29/00

(52) U.S. Cl. 47/48.5; 47/40.5

(57) ABSTRACT

A unit that directs water and air to roots of a plant includes a hollow sleeve having a wall member that defines an internal cavity therein with an open top and an open bottom. The unit has at least one hole formed in the wall member. The unit further includes an emitter having a first end and a second end, the first end being disposed through a selected hole in the wall member and being engaged to the wall member and a conduit coupled to the second end of the emitter.

### FIELD OF THE INVENTION

The present invention relates to watering and aerating, and more particularly to a device and method for watering and aerating plants.

### BACKGROUND OF THE INVENTION

Compacted soil is widely recognized as a significant threat to urban trees and shrubs as it inhibits the root systems of plants from absorbing oxygen, water and nutrients. It consequently weakens the plants so that they become more susceptible to disease and damage from insects. It is also known that while the “tap roots” of a tree may extend several feet below the surface of the soil, the “feeder roots” that are primarily responsible for the absorption of oxygen, water and nutrients are typically found within the first two to eight inches of soil.

Several devices have been developed in an effort to provide the roots of plants with oxygen, water or nutrients to aid in overcoming the effects of soil compaction. However, many of these devices are expensive to manufacture, time consuming to assemble, or both. Many of these devices involve the use of numerous pieces and the forming of complicated geometries. This results in both higher cost and longer assembly times. Many of these devices are also not readily adjustable.

Accordingly, it is desirable that a technician have an apparatus and method for use of such an apparatus that allows for watering and aeration in an effective manner that is both cost and time efficient.

### SUMMARY OF THE INVENTION

In one form, the present teachings provide a system for directing water, nutrients and air to the root system of a plant. The system may include an elongated hollow housing having a wall member with at least one hole that permits water and air to be transmitted therethrough and which defines an internal cavity with an open top and an open bottom. The system may further include an emitter having one end engaged to the wall of the hollow housing and the other end connected to a conduit.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a view of a combination watering and aerating unit constructed in accordance with the teachings of the present invention, the unit being illustrated installed in the soil and operatively associated with the roots of a tree;

FIG. 2 is a side view of a portion of the combination watering and aerating unit of FIG. 1;

FIG. 3 is a sectional view taken along the line 3-3 of FIG. 2;

FIG. 4 is an exploded perspective view of the combination watering and aerating unit of FIG. 1; and

FIG. 5 is a side view of an alternately constructed sleeve.

### DETAILED DESCRIPTION OF THE PREFERRED EMBODIMENTS

The following description of the preferred embodiment is merely exemplary in nature and is in no way intended to limit the invention, its application, or uses.

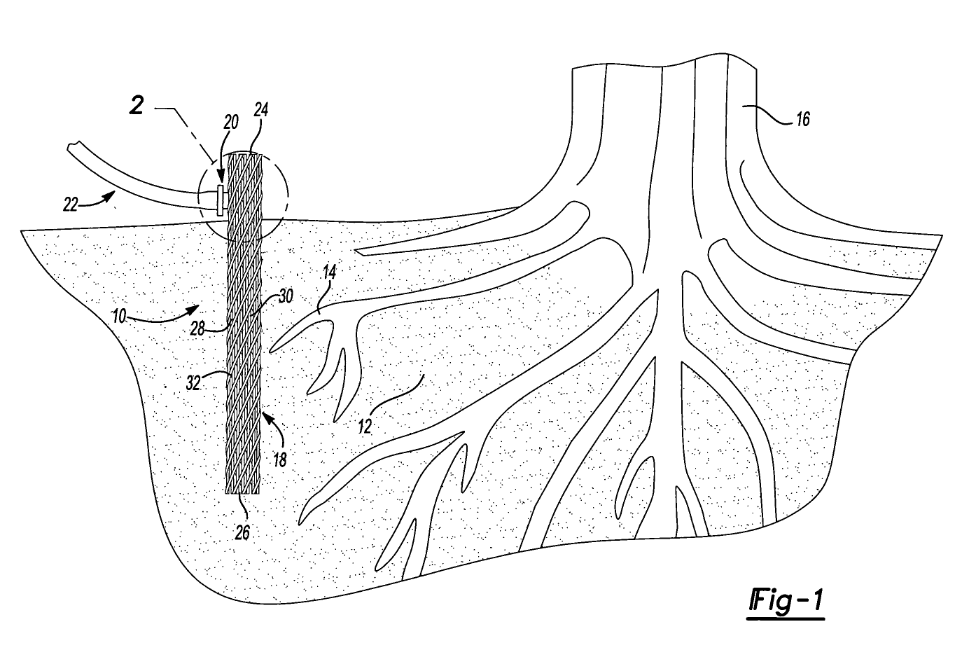

With reference to FIG. 1 of the drawings, a combination watering and aerating unit is constructed in accordance with the teachings of the present invention is generally indicated by reference numeral 10. The unit 10 is illustrated to be installed in the soil 12 proximate the feeder roots 14 of an exemplary plant 16, such as a tree. The unit 10 can include a sleeve 18, an emitter 20, and a conduit 22.

The sleeve 18 can have an open top 24, an open bottom 26, and a wall member 28 with at least one hole 30 therethrough. The sleeve 18 can be generally tubular in shape with a central cavity 32. The wall member 28 may be formed with a porosity or mesh that permits oxygen, water and/or nutrients to flow therethrough. The porosity or mesh may be sized and/or shaped to control or inhibit the migration of soil 12 that surrounds the exterior thereof into the central cavity 32.

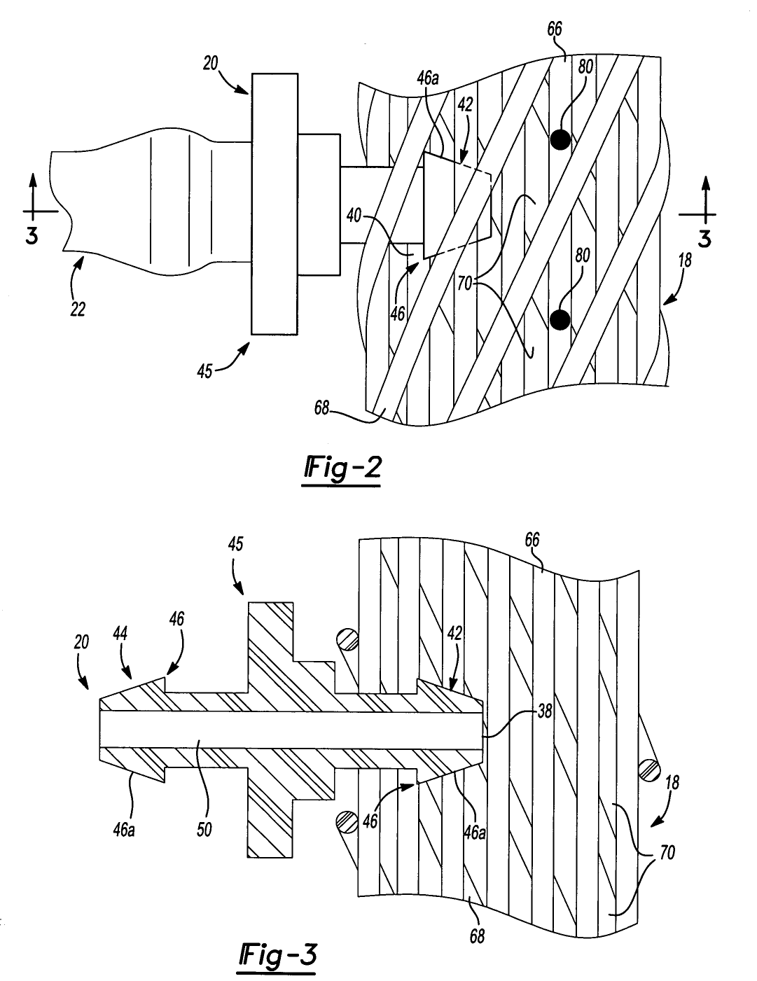

With reference to FIGS. 2 through 4, the sleeve 18 can include first and second sets of rod members 66 and 68, respectively. The first set of rod members 66 can be aligned generally parallel to the longitudinal axis of the sleeve 18 and the second set of rod members 68 can be coupled to and helically disposed about the first set of rod members 66 to thereby define a series of holes 70 between the first and second sets of rod members 66 and 68. The sleeve 18 may further include a series of markings 80 spaced apart from an end of the sleeve 18 at predetermined distances. The markings 80 may be made from paint, ink or another suitable substance. These markings may be used for easier determination of emitter 20 depth at installation.

In the particular example provided, the emitter 20 is a barbed connector (union) with a first end 42, which may be inserted into the conduit 22, a second end 44, which may be inserted into an associated hole 70 in the sleeve 18 to thereby attach the emitter 20 to the sleeve 18 at a desired location, and a body 45, which is disposed between the first and second ends 42 and 44. A flow channel 50 extends through the body 45 of the emitter 20. The flow channel 50 may be formed with a relatively small orifice 38 through which water may be metered (i.e., dispense water at a predetermined flow rate).

The first and second ends 42 and 44 may be configured in any convenient manner that facilitates the connection of the emitter 20 to the sleeve 18 and the conduit 22. In the particular example provided, the first and second ends 42 and 44 include a barbed connection 46. The barbed connection 46 can include a conical section 46a and a cylindrical portion 52 that is disposed between the body 45 and the conical section 46a. The size of the barbed connection 46 can be selected on the basis of the size of the holes 70 in the sleeve 18. In the particular example provided, a ¼″ hose barb is employed for each of the barbed connections 46. It will be appreciated that the size of the barbed connections 46 may be the same, as is illustrated, or may be different, depending on the size of the holes 70 and the conduit 22.

The conduit 22 can be formed of a suitable tubular material, such as polyethylene or vinyl or and can be employed to couple the emitter 22 to a source of water (FIG. 1).

The emitter 20 can be attached to the sleeve 18 by inserting the barbed connection 46 of the emitter 20 through a selected one of the holes 70 in the wall member 28. The construction of the sleeve 18 is such that the rod members of the first and second sets of rod members 66 and 68 that are adjacent the selected hole 40 elastically deflect outwardly from the barbed connection 46 as the barb of the barbed connection 46 is inserted and thereafter contract about the cylindrical portion 52 of the barbed connection 46 to thereby fixedly but removably couple the emitter 20 to the sleeve 18. The sleeve 18 may be compressed in an area proximate to the selected hole 40 to enlarge the size of a selected one of the holes 70 in order to more easily accommodate the insertion of the emitter 20.

The assembly of the unit 10 is fast and it allows for quick and easy adjustment to a variety of depths. One of the advantages of the current invention over the prior art is that it has fast assembly and adjustment times.

With reference to FIG. 5, an alternately constructed sleeve 72 is shown wherein the first set of rod members 74 are aligned generally parallel to the longitudinal axis of the sleeve 72 and the second set of rod members 76 extend generally circumferentially about the longitudinal axis and are coupled to the first set of rod members 74 to thereby define a series of holes 78 between the first and second sets of rod members 74 and 76.

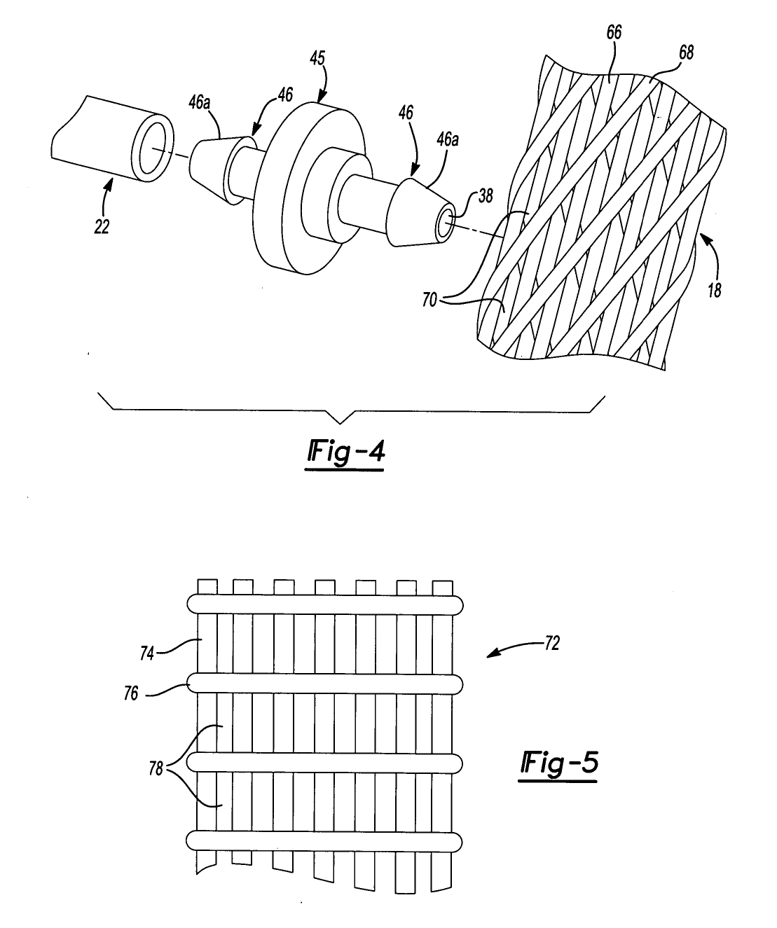

It will be appreciated that the sleeve 18 of FIG. 4 and the sleeve 72 of FIG. 5 may be configured such that the second set of rod members 68, 76 may be disposed either radially outwardly of the first set of rod members 66, 74 or radially inwardly of the first set of rod members 66, 74. Alternatively, the first set of rod members 66, 74 and second set of rod members 68, 76 could intersect one another and thus be neither radially inwardly nor outwardly extending from one another. The sleeve 18, 72 may be comprised of plastic, rubber, or any other material that is somewhat flexible and generally resilient to environmental conditions. These are merely a few examples of possible configurations of the sleeve 18, 72 and as those of ordinary skill in the art will appreciate from this disclosure, the sleeve 18, 72 may take many other forms as well. In this regard, the sleeve 18, 72 may be formed with a porosity or mesh, as previously mentioned, as long as there is a way for the emitter 20 to engage the wall member 28, while still allowing water and nutrients to flow therethrough.

With renewed reference to FIG. 1, the assembled unit 10 (e.g., sleeve 18, emitter 20 and conduit 22) may be installed in the ground proximate a plant 16 by drilling a hole in the soil 12 or creating a hole of a desired depth in the soil 12 near the plant 16 by some other means and thereafter placing the unit 10 in the hole. The depth of the unit 10 in the hole may be adjusted as necessary to place the open top 24 of the sleeve 18 at or above the level of the soil 12 (to promote aeration) and to place the emitter 20 at a desired level relative to the level of the soil 12, which can be at or above the level of the soil 12.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A combination watering and aerating unit consisting essentially of:
a hollow sleeve having a wall member with at least one hole formed therethrough;
an emitter having a first end and a second end, the first end being disposed through a selected hole in the wall member and being engaged to the wall member; and
a conduit coupled to the second end of the emitter.

2. The combination watering and aerating unit of claim 1, wherein the wall member includes a plurality of axially-spaced apart holes.

3. The combination watering and aerating unit of claim 2, wherein the wall member is defined by first and second sets of rod members, the first set of rod members being aligned generally parallel to a longitudinal axis of the hollow sleeve, the second set of rod members extending generally circumferentially about and being coupled to the first set of rod members.

4. The combination watering and aerating unit of claim 3, wherein the second set of rod members is disposed radially outwardly of the first set of rod members.

5. The combination watering and aerating unit of claim 3, wherein the second set of rod members are each helically disposed about the longitudinal axis of the hollow sleeve.

6. The combination watering and aerating unit of claim 2, wherein the hollow sleeve is marked with at least one mark, each mark being spaced apart from an end of the hollow sleeve by an associated predetermined distance.

7. The combination watering and aerating unit of claim 6, wherein at least one of a paint and an ink is employed to form the at least one mark.

8. The combination watering and aerating unit of claim 1, wherein the first end includes a barb.

9. The combination watering and aerating unit of claim 8, wherein the emitter includes a flange that is disposed between the first and second ends.

10. The combination watering and aerating unit of claim 1, wherein an emitter aperture of a predetermined size is formed through the first end.

11. A method comprising:
providing a hollow sleeve having a wall member with at least one hole forward therethrough; and
inserting an end of an emitter through a selected hole in the wall member such that when inserted the emitter engages the wall member to thereby fixedly couple the emitter to the hollow sleeve.

12. The method comprising of claim 11, wherein prior to inserting the emitter the hollow sleeve is compressed so as to flatten the hollow sleeve in an area proximate the selected hole.

13. The method comprising of claim 11, further comprising coupling a fluid conduit to an opposite end of the emitter.

14. The method comprising of claim 13, further comprising:
forming a hole in a soil bed proximate a selected plant; and
inserting the hollow sleeve into the hole in the soil.

15. The method comprising of claim 14, wherein the hollow sleeve is inserted into the hole in the soil to a predetermined depth.

16. The method comprising of claim 14, wherein the emitter is disposed at or above a soil level line when the hollow sleeve is inserted into the hole in the soil.
